(19) United States
(12) Patent Application Publication
(10) Pub. No.: US 2003/0014365 A1
(43) Pub. Date: Jan. 16, 2003

(54) Information processing method and program

(75) Inventors: Tetsuya Inada, Kanagawa (JP); Tatsuhiro Miyazaki, Kanagawa (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/100,905

(22) Filed: Mar. 20, 2002

(30) Foreign Application Priority Data
Jul. 16, 2001 (JP) 2001-215026

(51) Int. Cl. G06F 17/60; H04L 9/00; H04K 1/00

(52) U.S. Cl. 705/50

(57) ABSTRACT

A program capable of improving security of an information processing device handling a plurality of transactions. User identification information input section receives user identification information input thereto and identifying a user, and certificate acquiring section acquires a certificate certifying authenticity of the user. Correspondence storing section stores information indicating the correspondence between the user identification information and the certificate. When accessed from a certain user, certificate identifying section identifies, based on the user identification information from the user, a corresponding certificate. Based on the certificate identified by the certificate identifying section, user certification section verifies whether or not the user is an authentic user.

### BACKGROUND OF THE INVENTION

(1) Field of the Invention

The present invention relates to a program and an information processing method, and more particularly, to a program which causes a computer to function as an information processing device for exchanging information with other information processing devices via a network and to an information processing method for exchanging information with other information processing devices via a network.

(2) Description of the Related Art

In recent years, an increasing number of business transactions have come to be conducted on an open network typified by the Internet. To permit transactions to be conducted safely on such an open network, a means is needed to prevent risks of impersonation, eavesdropping or tampering of data, etc.

Conventionally, PKI (Public Key Infrastructure) is employed which provides an environment wherein data is encrypted using a public key available to anyone and is decrypted using a secret key possessed by an individual only, thereby to ensure secure transactions.

Public key encryption techniques require that the originator of communication should be “true”. Thus, in the case of PKI, a “reliable” certification organization called Certification Authority (CA) is established to provide a mechanism whereby a public key is published together with an “electronic certificate” including an electronic signature and is managed to certify the authenticity of the originator. This prevents not only eavesdropping and tampering of communication data but also impersonation of the originator.

According to conventional techniques, however, a certificate is generally issued on a server-by-server basis. A security problem therefore arises in cases where a single server is shared by a plurality of users (e.g., by a plurality of companies or by different divisions of the same company), for example.

Also, a root CA certificate should originally be unique in the world and all end-entity certificates should be subordinate to the root CA certificate; in actuality, however, there exist a plurality of top-level certification authorities. An end-entity certificate can be used only by the user who obtained the certificate. However, in cases where a plurality of different transactions are conducted by a single system, there will exist multiple local system certificates and the system administrator can use all certificates, giving rise to a security problem.

Further, in the case of transmitting encrypted data to a system handling a plurality of different transactions, data can be encrypted using any one of the certificates, also giving rise to a security problem.

Also, in general, OCSP (Online Certificate Status Protocol) and certificate are kept in case of trouble, with a view to looking into the cause of the trouble. However, since OCSP and certificate are huge in data quantity, a problem arises in that a large part of the capacity of a storage device is occupied by such data.

### SUMMARY OF THE INVENTION

The present invention was created in view of the above circumstances, and an object thereof is to provide a program which permits secure exchange of data by an information processing device for handling a plurality of transactions, and an information processing method for exchanging information with other information processing devices via a network.

To achieve the object, there is provided a program for causing a computer to function as an information processing device for exchanging information with other information processing devices via a network. The program causes the computer to function as user identification information input means for receiving user identification information input thereto and identifying a user, certificate acquiring means for acquiring a certificate certifying authenticity of the user, correspondence storing means for storing information indicating a correspondence between the user identification information and the certificate, certificate identifying means responsive to access from a certain user, for identifying, based on user identification information from the certain user, a corresponding certificate, and user certification means for verifying based on the certificate identified by the certificate identifying means whether or not the certain user is an authentic user.

Also, to achieve the above object, there is provided an information processing method for exchanging information with other information processing devices via a network. The information processing method comprises a user identification information input step of receiving input user identification information identifying a user, a certificate acquiring step of acquiring a certificate certifying authenticity of the user, a correspondence storing step of storing information indicating a correspondence between the user identification information and the certificate, a certificate identifying step of identifying, in response to access from a certain user and based on user identification information from the certain user, a corresponding certificate, and a user certification step of verifying based on the certificate identified in the certificate identifying step whether or not the certain user is an authentic user.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram illustrating the principle of operation according to the present invention;

FIG. 2 is a diagram showing an exemplary configuration according to an embodiment of the present invention;

FIG. 3 is a diagram showing an exemplary configuration of a server appearing in FIG. 2;

FIG. 4 is a diagram showing an exemplary configuration according to a first embodiment of the present invention;

FIG. 5 is a flowchart illustrating an example of a process executed when a user registration command is input in the embodiment shown in FIG. 4;

FIG. 6 is a flowchart illustrating an example of a process for verifying, with the use of a user ID and a label key registered in the process shown in FIG. 5, whether the user is an authentic user or not at the time of access from the user in the embodiment shown in FIG. 4;

FIG. 7 is a diagram showing an exemplary configuration according to a second embodiment of the present invention;

FIG. 8 is a flowchart illustrating an example of a process executed when a message is received from a remote system in the embodiment shown in FIG. 7;

FIG. 9 is a diagram showing an exemplary configuration according to a third embodiment of the present invention;

FIG. 10 is a flowchart illustrating an example of a process executed when an advance registration command is input in the embodiment shown in FIG. 9;

FIG. 11 is a flowchart illustrating an example of a process executed when a message is received from a remote system in the embodiment shown in FIG. 9;

FIG. 12 is a diagram showing an exemplary configuration according to a fourth embodiment of the present invention;

FIG. 13 is a flowchart illustrating an example of a process executed when an OCSP issue interval registration command is input in the embodiment shown in FIG. 12;

FIG. 14 is a flowchart illustrating an example of a process executed when a message is received from a remote system in the embodiment shown in FIG. 12;

FIG. 15 is a diagram showing an exemplary configuration according to a fifth embodiment of the present invention; and

FIG. 16 is a flowchart illustrating an example of a process executed when a message is received from a remote system in the embodiment shown in FIG. 15.

### DESCRIPTION OF THE PREFERRED EMBODIMENTS

Embodiments of the present invention will be hereinafter described with reference to the drawings.

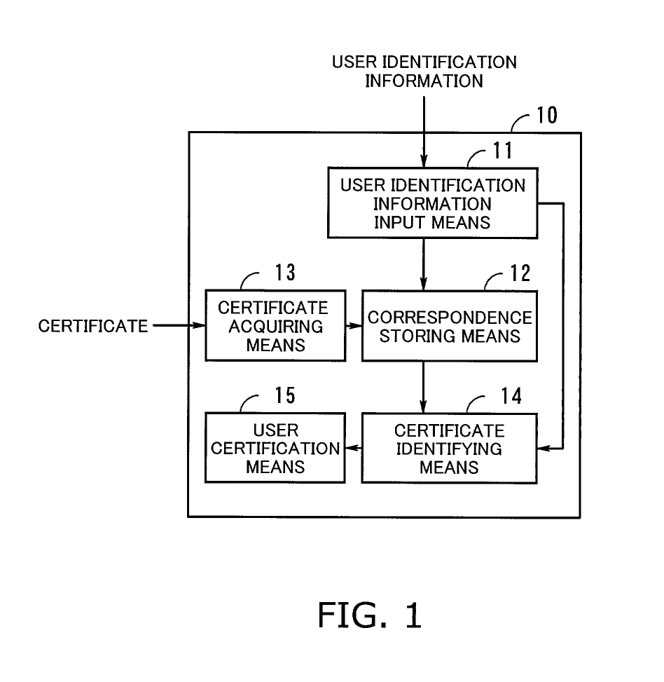

FIG. 1 illustrates the principle of operation according to the present invention. As shown in the figure, an information processing device 10 according to the present invention comprises user identification information input means 11, correspondence storing means 12, certificate acquiring means 13, certificate identifying means 14, and user certification means 15.

The user identification information input means 11 receives user identification information input thereto and identifying a user.

The certificate acquiring means 13 acquires, via a network, not shown, a certificate certifying authenticity of the user.

The correspondence storing means 12 stores information indicating the correspondence between the user identification information and the certificate.

The certificate identifying means 14 is responsive to access from a certain user, to identify, based on the user identification information from the user, a corresponding certificate.

The user certification means 15 verifies based on the certificate identified by the certificate identifying means 14 whether or not the user in question is an authentic user.

Operation according to the illustrated principle will be now described.

First, operation for registering user identification information and a certificate will be explained.

When starting a predetermined transaction, a user inputs information identifying himself/herself, for example, a user ID, and also enters a command to acquire a predetermined certificate.

Consequently, the information processing device 10 acquires a certificate via the network, not shown, and stores the acquired certificate in the correspondence storing means 12 in a manner associated with the user ID.

With the certificate and the user ID stored in this manner, if the user accesses the information processing device 10, the device 10 requests the user to input user identification information. If, in response to the request, the user ID as the user identification information is input, it is supplied to the certificate identifying means 14.

The certificate identifying means 14 determines whether or not there exists a certificate corresponding to the user ID supplied thereto. If it is ascertained that a corresponding certificate has already been registered, a notification to that effect is supplied to the user certification means 15.

When the corresponding certificate has been identified by the certificate identifying means 14, the user certification means 15 certifies that the accessing user is an authentic user.

As described above, according to the present invention, information indicating the correspondence between the user identification information identifying a user and its corresponding certificate is stored in the correspondence storing means 12, and accordingly, the information processing device 10 possesses certificates classified according to users (transactions). It is therefore possible to solve a problem with conventional devices that an identical certificate suffices to access different transactions regardless of the kinds of transactions, thus enhancing security.

Various embodiments of the present invention will be now described.

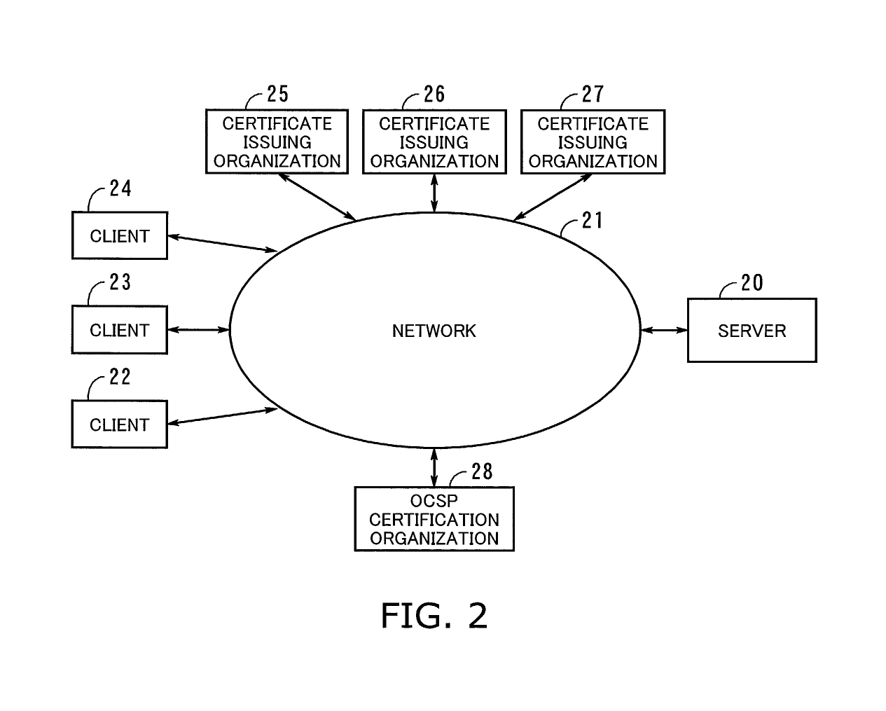

FIG. 2 shows an exemplary system configuration according to one embodiment of the present invention. As shown in the figure, the embodiment of the invention comprises a server 20, a network 21, clients 22 to 24, certificate issuing organizations 25 to 27, and an OCSP certification organization 28.

The server 20, which manages transactions for a plurality of users, accepts accesses from the respective clients 22 to 24, and provides predetermined services.

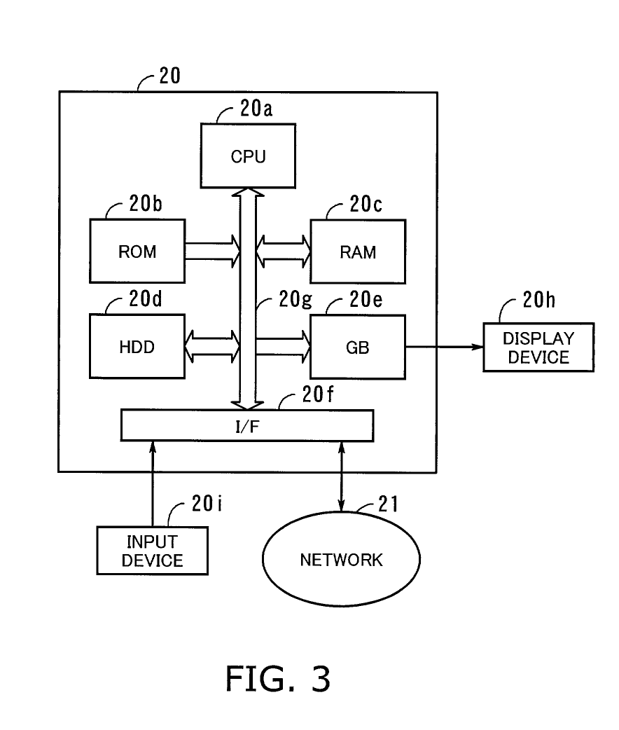

FIG. 3 shows in detail an exemplary configuration of the server 20. As shown in the figure, the server 20 comprises a CPU (Central Processing Unit) 20a, a ROM (Read Only Memory) 20b, a RAM (Random Access Memory) 20c, an HDD (Hard Disk Drive) 20d, a GB (Graphics Board) 20e, an I/F (Interface) 20f, a bus 20g, a display device 20h, and an input device 20i.

The CPU 20a performs various operations and controls individual parts of the server in accordance with programs stored in the HDD 20d.

The ROM 20b stores basic programs etc. to be executed by the CPU 20a.

While the CPU 20a performs various operations, the RAM 20c temporarily stores data derived in the middle of operations as well as programs under execution.

The HDD 20d stores programs to be executed by the CPU 20a and various other data.

The GB 20e performs a drawing process in accordance with draw instructions supplied from the CPU 20a, and converts the obtained image data into video signal, which is then supplied to the display device 20h.

The I/F 20f alters the form of representation of data output from the input device 20i to make it fit for input, and also exchanges data with the network 21 according to predetermined protocols.

The display device 20h comprises a CRT (Cathode Ray Tube) monitor or the like, for example, and displays the video signal output from the GB 20e.

The input device 20i comprises a keyboard and a mouse, for example, and generates and outputs data according to the user's manipulation.

Referring again to FIG. 2, the network 21 comprises, for example, an open network such as the Internet. In the illustrated embodiment, the server 20, the clients 22 to 24, the certificate issuing organizations 25 to 27 and the OCSP certification organization 28 are interconnected by the same network 21, but the network configuration may alternatively include a LAN (Local Area Network) as a part thereof such that some of the elements are connected to the LAN.

The clients 22 to 24 individually access the server 20 to exchange predetermined data therewith.

The certificate issuing organizations 25 to 27 each issue a certificate to the server 20 and the clients 22 to 24.

The OCSP certification organization 28 checks authenticity of the certificates issued by the certificate issuing organizations 25 to 27.

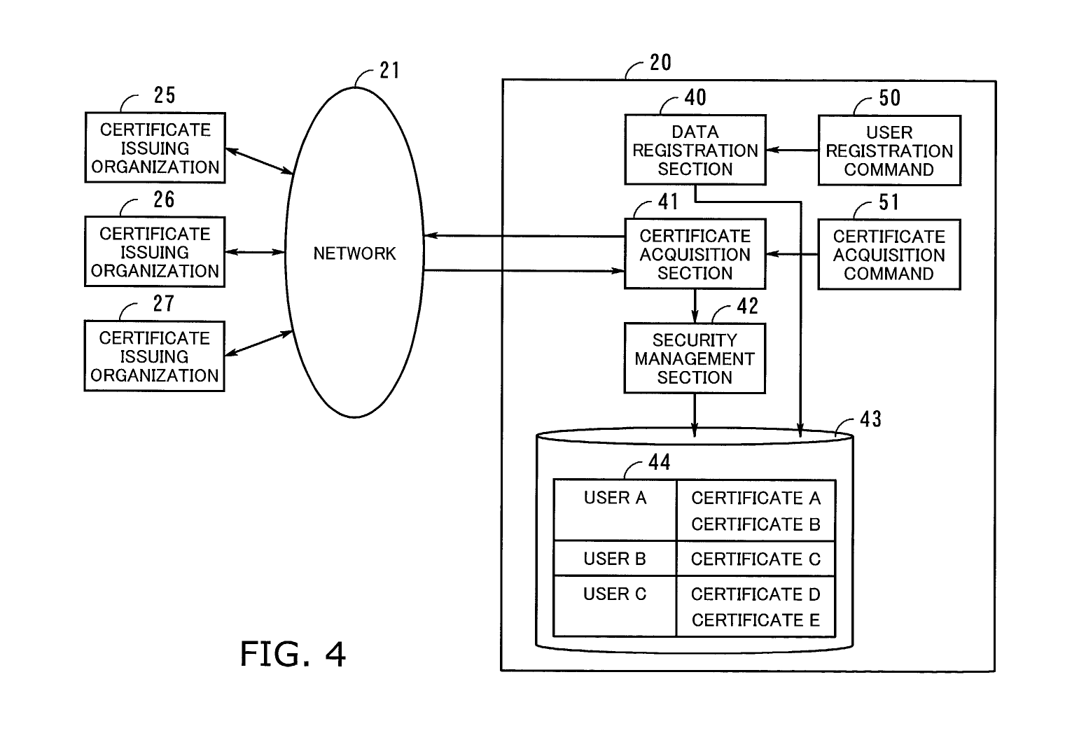

FIG. 4 is a block diagram showing a first embodiment of the present invention. Various functions shown in the block diagram are accomplished when a predetermined program stored in the HDD 20d in FIG. 3 is executed.

As shown in the figure, the first embodiment of the present invention comprises a data registration section 40, a certificate acquisition section 41, a security management section 42, and a database 43.

Upon input of a user registration command 50, the data registration section 40 registers a user ID in the database 43.

When a certificate acquisition command 51 has been entered, the certificate acquisition section 41 acquires a certificate from the certificate issuing organization 25, 26, 27 and stores the acquired certificate in the database 43.

In response to access from a user who uses the server 20, the security management section 42 requests the user to input his/her user ID, and determines whether or not the user ID obtained as a result is registered in the database 43. If the user ID is registered, the security management section 42 regards the user as an authentic user and permits the access.

The database 43 stores a table 44 in which user IDs are correlated with label keys of certificates.

Operation of the above embodiment will be now described.

First, if a certain user who uses the server 20 inputs the user registration command 50, the data registration section 40 accepts the input user ID and stores the user ID in the database 43.

Then, if the user enters the certificate acquisition command 51 to acquire a certificate for his/her own system, the certificate acquisition section 41 accesses a predetermined one of the certificate issuing organizations 25 to 27 via the network 21 and acquires a certificate. The certificate acquisition section 41 then acquires a label key from the certificate and stores the label key in the table 44 of the database 43. The certificate itself is also stored in the database 43.

The process described above permits user IDs and the label keys of certificates to be stored in the table 44 of the database 43 in a manner associated with each other. In the example shown in FIG. 4, the user ID of a user A and certificates A and B are stored in a manner associated with each other. Thus, a plurality of certificates can be correlated with a single user ID so that, in cases where a user conducts multiple transactions, for example, different certificates can be correlated with the respective transactions.

Subsequently, in response to access from a user who is to conduct a certain transaction, the security management section 42 requests the user to input his/her user ID. Upon entry of the user ID, the security management section 42 searches the table 44 of the database 43 to ascertain whether the user ID is stored in the table 44 or not.

If, as a result, the user ID is found and also if there exists a label key correlated with the user ID, the user is judged an authentic user and the process is continued; otherwise the process is discontinued.

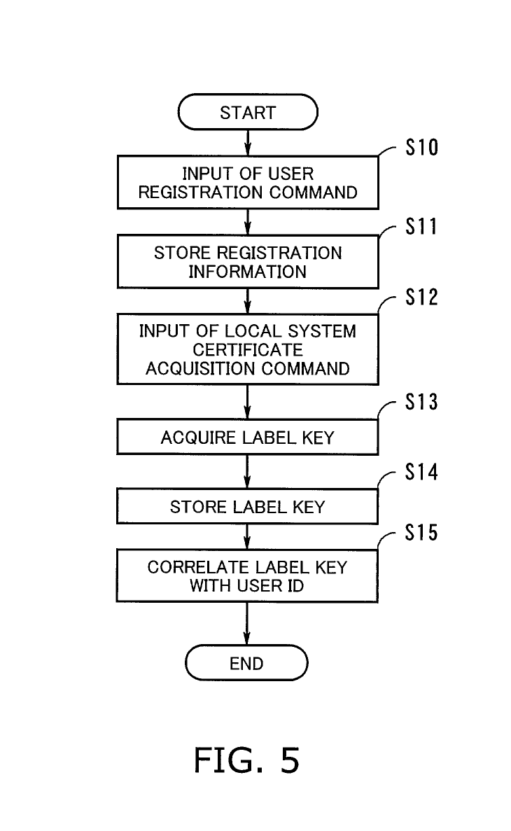

FIG. 5 is a flowchart illustrating an example of a process executed when the user registration command 50 is input. Upon start of the process shown in the flowchart, the following steps are executed.

Step S10:

The data registration section 40 receives the user registration command 50 input thereto.

Step S11:

The data registration section 40 stores the user ID, which is registration information, in a predetermined area of the table 44 in the database 43.

Step S12:

The certificate acquisition section 41 receives the certificate acquisition command 51 input thereto for the acquisition of a local system certificate.

Step S13:

The certificate acquisition section 41 accesses the certificate issuing organization 25, 26, 27 via the network 21 to acquire a predetermined certificate, and obtains a label key from the acquired certificate.

Step S14:

The certificate acquisition section 41 stores the acquired label key in the table 44.

Step S15:

The certificate acquisition section 41 correlates the label key with the user ID.

The above process permits the user ID and the label key of the certificate to be registered in the table 44 in a manner associated with each other.

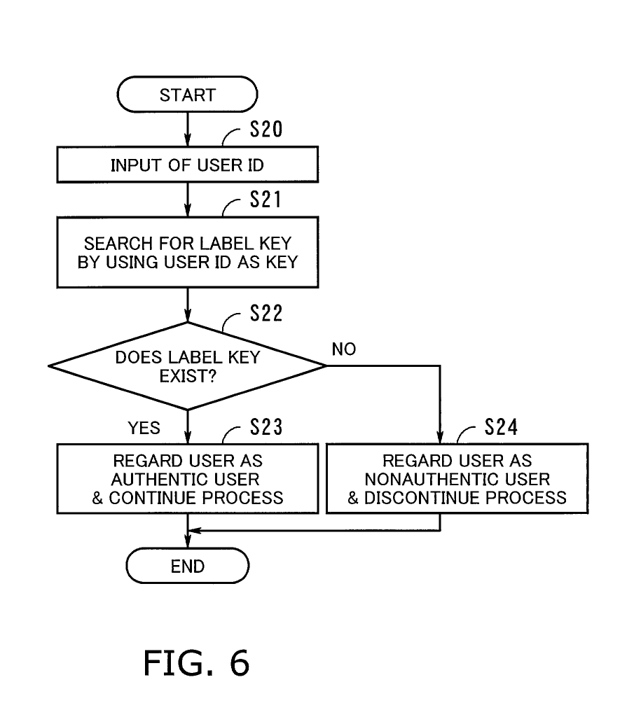

Referring now to the flowchart of FIG. 6, an example of process will be described which is executed in response to access from a user to verify whether the user is an authentic user or not by using the user ID and the label key registered in the process shown in FIG. 5. Upon start of the process shown in the flowchart, the following steps are executed.

Step S20:

The security management section 42 receives the user ID input thereto from an accessing user.

Step S21:

Using the input user ID as a key, the security management section 42 searches the table 44 of the database 43 for a corresponding label key.

Step S22:

The security management section 42 determines whether or not the corresponding label key exits. If the corresponding label key exists, the flow proceeds to Step S23; if not, the flow proceeds to Step S24.

Step S23:

The security management section 42 regards the user as an authentic user and continues the process.

Step S24:

The security management section 42 regards the user as a nonauthentic user and thus discontinues the process.

According to the aforementioned process shown in the flowchart, when a user accesses the server, his/her user ID is used as a key to search for a corresponding label key, and if a corresponding label key exists, the user is judged an authentic user.

As described above, according to the first embodiment of the present invention, the user ID and the label key of the certificate are stored in a manner associated with each other, and when a user accesses the server, his/her user ID is used as a key to search for a corresponding label key. If a corresponding label key exists, the user is judged an authentic user, whereby security can be improved.

In the above embodiment, the label key is stored in a manner associated with the user ID, but some other information may be used instead.

A second embodiment of the present invention will be now described.

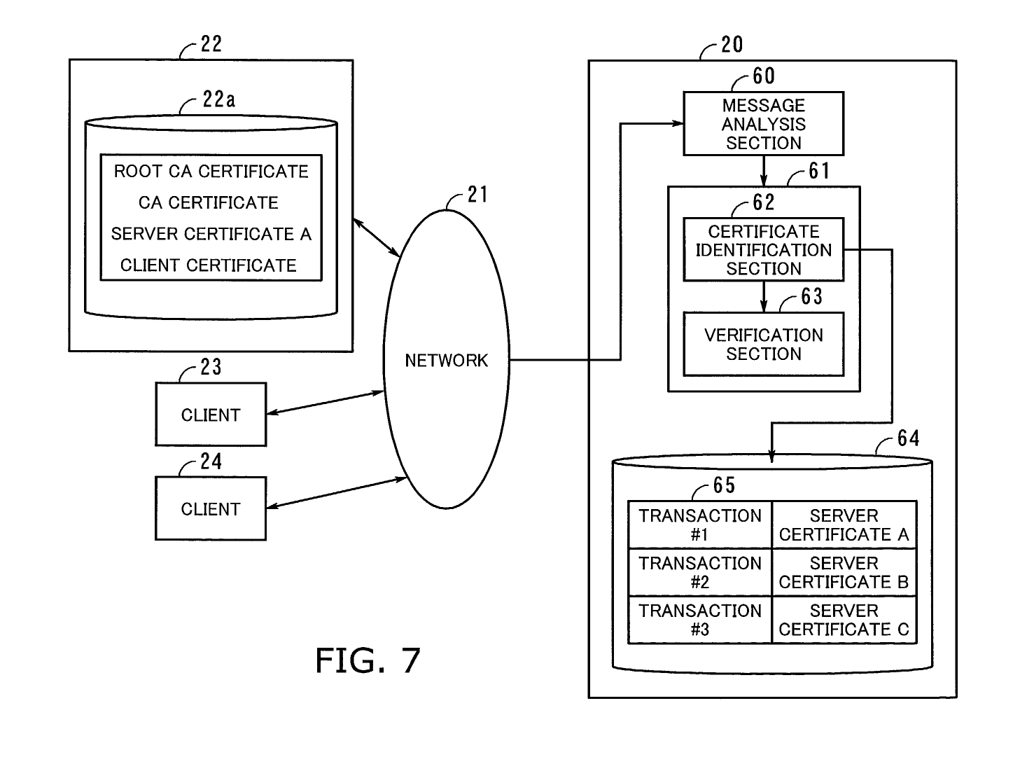

FIG. 7 is a block diagram showing the second embodiment of the present invention. Various functions shown in the block diagram are accomplished when a predetermined program stored in the HDD 20d in FIG. 3 is executed.

As shown in the figure, the second embodiment of the present invention comprises a message analysis section 60, a security management section 61 including a certificate identification section 62 and a verification section 63, and a database 64.

The message analysis section 60 analyzes encrypted data (messages) transmitted from the clients 22 to 24.

In response to access from the client 22, 23, 24, the security management section 61 identifies a corresponding certificate to verify authenticity.

The certificate identification section 62 looks up data included in the received message and identifying a certificate, to identify a corresponding certificate.

The verification section 63 compares a transaction corresponding to the identified certificate with transaction-indicative data included in the message, to verify authenticity of the client.

The database 64, which stores a table 65 in which transactions are correlated with respective server certificates (or information specifying the server certificates), is responsive to a request from the certificate identification section 62 to search for a corresponding certificate and returns a transaction corresponding to the certificate.

The client 22 has a database 22a storing a root CA certificate, a CA certificate, a server certificate A, and a client certificate.

The root CA certificate is a certificate issued by a root (top-level) certificate issuing organization.

The CA certificate is a certificate issued by a certificate issuing organization belonging to a level lower than the root certificate issuing organization.

The server certificate A is a certificate which has been transmitted from the server 20 and which certifies authenticity of a predetermined transaction (in this example, transaction #1) of the server 20.

The client certificate is a certificate which certifies authenticity of the client.

Each of the clients 23 and 24 also has similar information stored in a database thereof.

Operation of the above embodiment will be now described.

Let it be assumed first that the client 22, which has an access right to the transaction #1 provided by the server 20, accesses the server 20 via the network 21 and transmits a predetermined message to the server 20.

The message analysis section 60 of the server 20 first analyzes the message to acquire the transaction name of a service which the client has requested. Then, using Issuer & Serial included in a non-encrypted part of the message as a key, the message analysis section 60 acquires a corresponding server certificate from the table 65 of the database 64.

In this example, the message transmitted from the client 22 is encrypted by means of a public key included in the client certificate, and accordingly, the “server certificate A” is specified.

Subsequently, the certificate identification section 62 identifies a transaction corresponding to the server certificate A from the table 65 of the database 64. As a result, the “transaction #1” is identified.

The verification section 63 then compares the transaction identified by the certificate identification section 62 with the transaction acquired from the message by the message analysis section 60, to determine whether or not the two are the same. In this example, the transaction name acquired from the message is “transaction #1” and the transaction name acquired from the database 64 is also “transaction #1”, so that authenticity of the client 22 as well as the transaction is verified. Accordingly, the server 20 decides to continue the process with respect to the client 22.

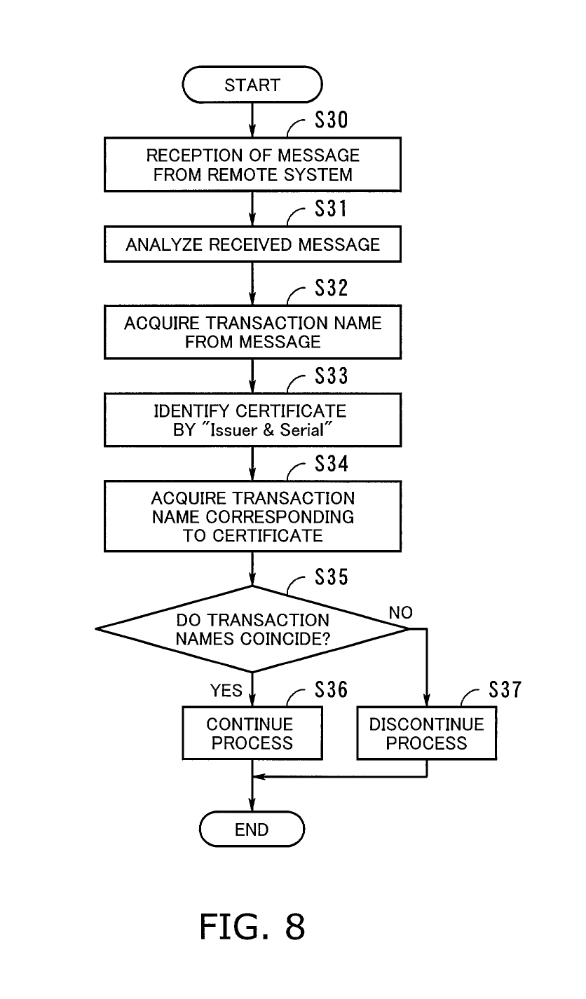

Referring now to the flowchart of FIG. 8, an exemplary process for performing the aforementioned function will be described. Upon start of the process shown in the flowchart, the following steps are executed.

Step S30:

The message analysis section 60 of the server 20 receives a message from a remote system.

Step S31:

The message analysis section 60 analyzes the received message.

Step S32:

The message analysis section 60 acquires a transaction name from the received message.

Step S33:

The message analysis section 60 acquires Issuer & Serial included in the non-encrypted part of the received message, and supplies the acquired Issuer & Serial to the certificate identification section 62. The certificate identification section 62 searches the database 64 to identify a corresponding certificate.

Step S34:

The certificate identification section 62 acquires a transaction name corresponding to the certificate from the database 64.

Step S35:

The verification section 63 determines whether or not the transaction name extracted in Step S32 from the received message by the message analysis section 60 and the transaction name acquired in Step S34 from the database 64 by the certificate identification section 62 coincide with each other. If the two transaction names coincide, the flow proceeds to Step S36; if not, the flow proceeds to Step S37.

Step S36:

The server 20 judges that the accessing client is an authentic client and also that the transaction could be identified, so that the process with respect to the client is continued.

Step S37:

The server 20 judges that the accessing client is not an authentic client or that the transaction could not be identified, so that the process with respect to the client is discontinued.

According to the process described above, when the server 20 handling a plurality of transactions is accessed from any of the clients 22 to 24, it can identify a transaction and a certificate by determining whether or not the transaction name included in the message and the transaction name identified by Issuer & Serial included in the message coincide with each other, thereby solving the problem with the conventional system that all transactions can be accessed by means of a single certificate.

A third embodiment of the present invention will be now described.

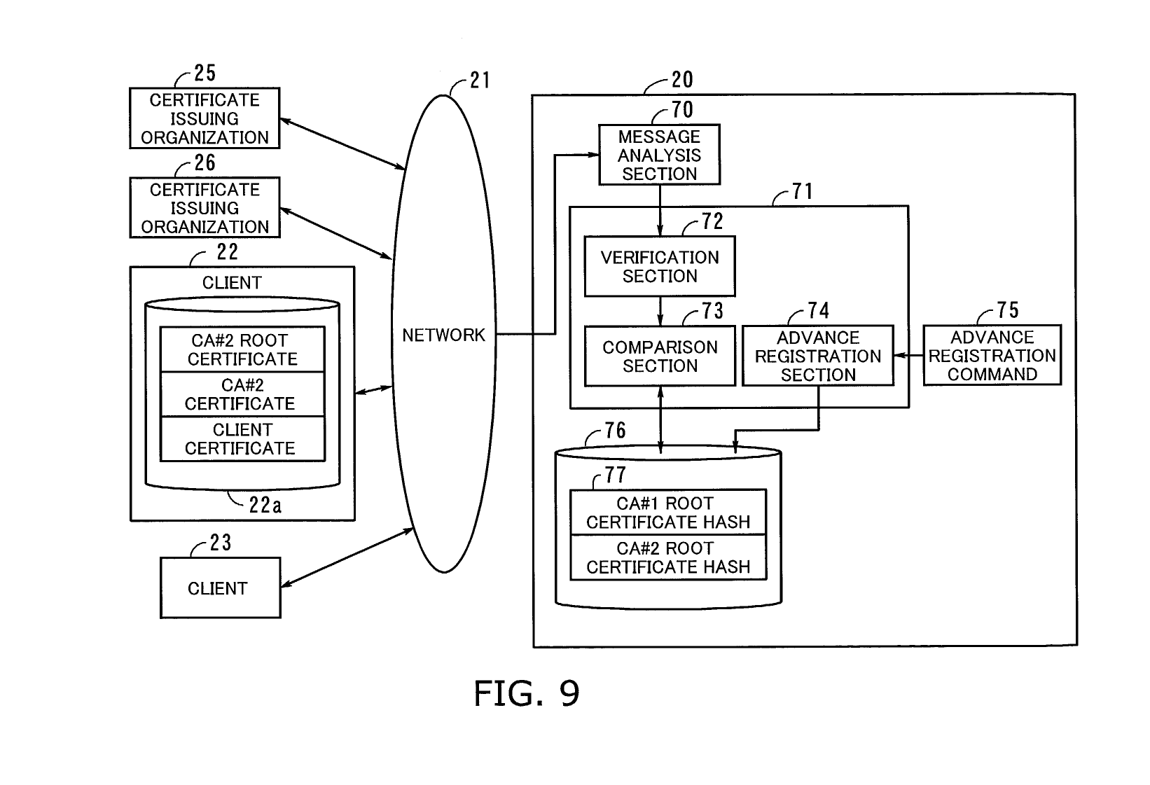

FIG. 9 is a block diagram showing the third embodiment of the present invention. Various functions illustrated in the block diagram are accomplished when a predetermined program stored in the HDD 20d in FIG. 3 is executed.

As shown in the figure, the third embodiment of the present invention comprises a message analysis section 70, a security management section 71, and a database 76.

The message analysis section 70 analyzes a message transmitted from the clients 22 and 23.

The security management section 71, which includes a verification section 72, a comparison section 73 and an advance registration section 74, is responsive to access from a remote system to perform a process for verifying authenticity of the remote system.

The verification section 72 performs a process for verifying authenticity of a received certificate.

When a root certificate whose authenticity is unknown, that is, “unknown root certificate” is received, the comparison section 73 compares the certificate with a “root certificate hash” registered in advance and obtained by hashing a root certificate, to thereby verify authenticity of the received certificate.

The advance registration section 74 registers, in a table 77 of the database 76, the root certificate hash obtained by hashing the root certificate.

The client 22 has a database 22a in which are stored a CA#2 root certificate, which is a root certificate issued by a root certificate issuing organization (e.g., certificate issuing organization 25), a CA#2 certificate, which is a certificate issued by a certificate issuing organization (e.g., certificate issuing organization 26) belonging to a level lower than the root certificate issuing organization, and a client certificate for verifying its own authenticity.

Operation of the above embodiment will be now described.

First, when an advance registration command 75 is input to the advance registration section 74 by a user, the advance registration section 74 requests entry of a root certificate hash obtained by hashing a certificate from a root certification organization. If a “CA#1 root certificate hash” obtained by hashing a CA#1 root certificate from the root certificate issuing organization 25 is input, for example, the advance registration section 74 stores the input CA#1 root certificate hash in the table 77 of the database 76.

With the CA#1 root certificate hash stored in this manner, if a message including an unknown CA root certificate (CA#2 root certificate hash) is transmitted from a remote system, for example, from the client 23, the message analysis section 70 of the server 20 acquires the unknown CA root certificate.

Then, the verification section 72 of the security management section 71 verifies root of the certificate included in the message. If, as a result, the certificate is found to be an unknown CA root certificate, the verification section 72 hashes the CA root certificate and supplies the obtained data to the comparison section 73.

The comparison section 73 compares the data supplied from the verification section 72 with CA root certificate hashes stored in the table 77 in the database 76, to determine whether or not a corresponding CA root certificate hash exists.

If it is found as a result of comparison that there exists a corresponding CA root certificate hash (in this example, CA#2 root certificate hash), it is judged that the root CA is authenticated and the process with respect to the accessing client is continued.

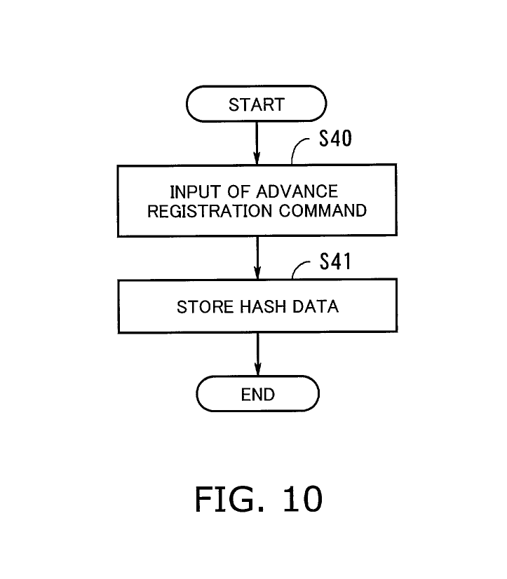

Referring now to the flowchart of FIG. 10, an exemplary process for performing the aforementioned function will be described. The process shown in FIG. 10 is executed when the advance registration command 75 is input. Upon start of the process shown in the flowchart, the following steps are executed.

Step S40:

The advance registration section 74 of the server 20 receives the advance registration command 75 input thereto from a user.

Step S41:

The advance registration section 74 requests the user who has entered the advance registration command 75 to input hash data, and stores the hash data input in response to the request, that is, CA root certificate hash, in a predetermined region of the table 77 in the database 76.

The CA root certificate hash is recorded on and supplied in the form of a recording medium such as an FD (Flexible Disk), for example.

The above process makes it possible to register a CA root certificate hash in the table 77 of the database 76 when the advance registration command 75 has been input.

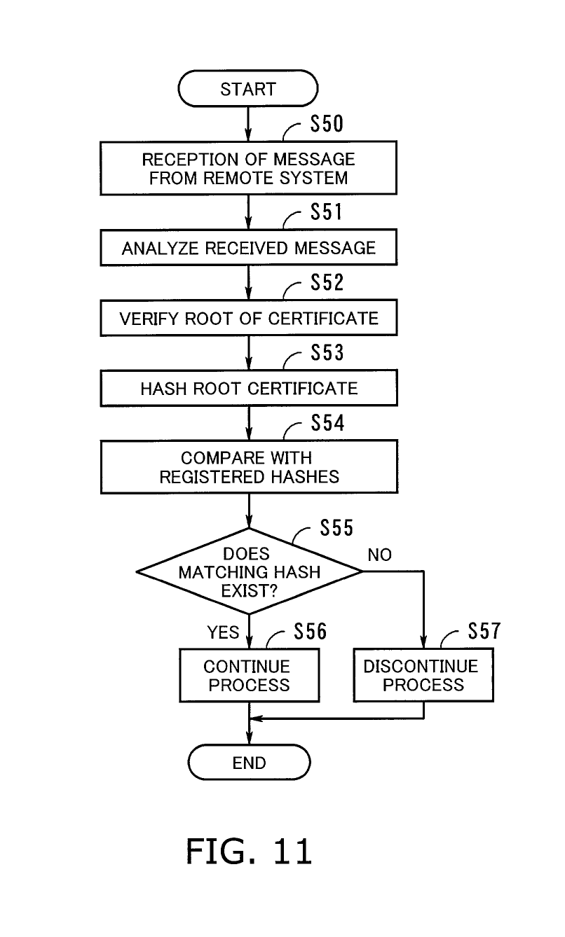

Referring now to the flowchart of FIG. 11, a process executed when a message is transmitted from a client will be described. Upon start of the process shown in the flowchart, the following steps are executed.

Step S50:

The message analysis section 70 receives a message transmitted from a remote system.

Step S51:

The message analysis section 70 executes a process for analyzing the received message.

Step S52:

The verification section 72 executes a process for verifying the root of the client certificate.

Step S53:

The verification section 72 hashes the acquired root certificate to obtain a CA root certificate hash.

Step S54:

The comparison section 73 compares the CA root certificate hash obtained by the verification section 72 with CA root certificate hashes stored in the table 77 of the database 76.

Step S55:

The comparison section 73 determines whether or not there exists a matching CA root certificate hash. If a matching CA root certificate hash exists, the flow proceeds to Step S56; if not, the flow proceeds to Step S57.

Step S56:

The server 20 recognizes that the accessing client is an authentic client, and thus continues the process.

Step S57:

The server 20 recognizes that the accessing client is not an authentic client, and thus discontinues the process.

According to the above process, even in cases where access is made from a client having a different CA root certificate, the certificate can be checked with ease for authenticity, thus making it possible to improve the security of the system.

A fourth embodiment of the present invention will be now described.

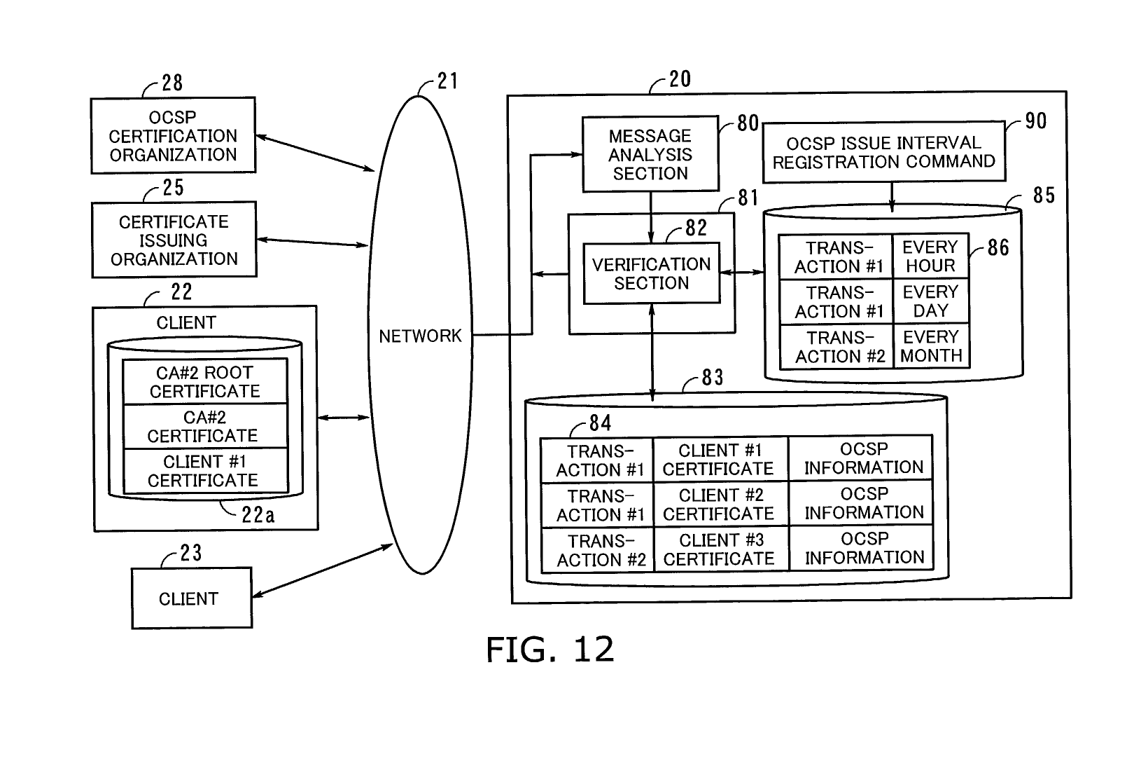

FIG. 12 is a block diagram showing the fourth embodiment of the present invention. Various functions illustrated in the block diagram are accomplished when a predetermined program stored in the HDD 20d in FIG. 3 is executed.

As shown in the figure, the fourth embodiment of the present invention comprises a message analysis section 80, a security management section 81, and databases 83 and 85.

The message analysis section 80 analyzes a message transmitted from the clients 22 and 23.

The security management section 81, which comprises a verification section 82, verifies authenticity of the client.

The database 83 has a table 84 in which transaction names, client certificates and OCSP information are stored in a manner associated with each other.

The database 85 has a table 86 in which transactions and information indicating OCSP issue intervals for the respective transactions are stored in a manner associated with each other.

Operation of the above embodiment will be now described.

A user inputs an OCSP issue interval registration command 90, whereupon the server 20 requests entry of an OCSP issue interval.

If, in response to the request, data indicating “every hour” is entered as the issue interval for “transaction #1”, for example, the data is stored in a predetermined region of the table 86 in the database 85 in a manner associated with the transaction name “transaction #1”.

With the issue interval stored in this manner, if a message is received from a remote system, for example, from the client 22, the message analysis section 80 executes a process for analyzing the received message, to acquire a transaction name included in the message.

The message analysis section 80 supplies the acquired transaction name, for example, “transaction #1”, to the verification section 82 of the security management section 81.

Using “transaction #1” as a key, the verification section 82 searches the table 84 of the database 83, and acquires a corresponding client certificate and OCSP information as a result.

The OCSP information is information indicating the history of access to the OCSP certification organization 28, and by looking up the information, it is possible to specify the date and time of the preceding access.

Then, using “transaction #1” as a key in like manner, the verification section 82 searches the table 86 of the database 85 to acquire information about the OCSP issue interval. In this example, “every hour” is acquired.

Subsequently, the verification section 82 checks the acquired OCSP information, the current date and time acquired from a time measurement section, not shown, and the OCSP issue interval acquired from the database 85, to determine whether or not the time elapsed from the last access to the OCSP certification organization 28 is longer than the issue interval. If the elapsed time is longer than the issue interval, the verification section 82 accesses the OCSP certification organization 28 to again verify the authenticity of the client #1 certificate of the accessing client 22.

If, as a result, the authenticity of the certificate can be verified, then it is concluded that the client 22 is authenticated, and the process with respect to the client 22 is continued.

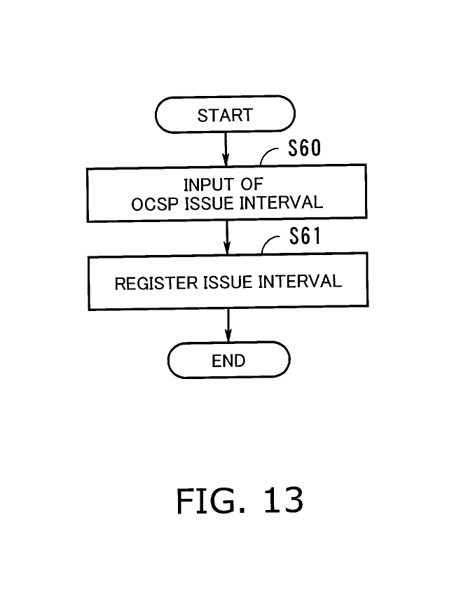

Referring now to the flowchart of FIG. 13, an exemplary process for performing the aforementioned function will be described. The process shown in FIG. 13 is executed when the OCSP issue interval registration command 90 is input. Upon start of the process shown in the flowchart, the following steps are executed.

Step S60:

The server 20 receives an OCSP issue interval input thereto in relation to a certain transaction.

Step S61:

The server 20 stores the transaction name and the OCSP issue interval in the table 86 of the database 85 in a manner associated with each other.

The above process permits a transaction name and its corresponding OCSP issue interval to be registered in the table 86 of the database 85.

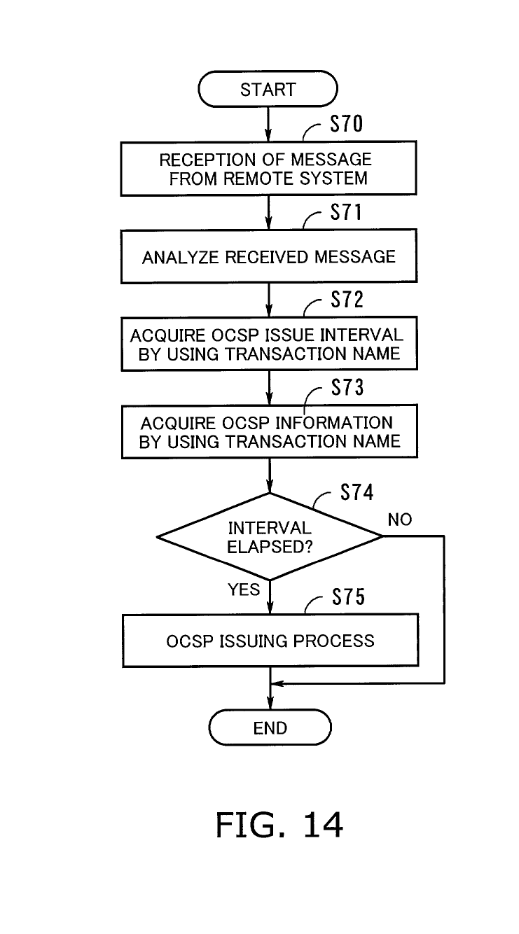

Referring now to the flowchart of FIG. 14, a process executed when a message is transmitted from a remote system will be described. Upon start of the process shown in the flowchart, the following steps are executed.

Step S70:

The message analysis section 80 receives a message from a client which is a remote system.

Step S71:

The message analysis section 80 executes a process for analyzing the received message.

Step S72:

The verification section 82 acquires, from the database 85, an OCSP issue interval corresponding to the transaction name extracted from the received message.

Step S73:

The verification section 82 acquires, from the database 83, OCSP information corresponding to the transaction name extracted from the received message.

Step S74:

The verification section 82 checks the OCSP issue interval acquired in Step S72, the OCSP information acquired in Step S73 and the current date and time, to determine whether or not the issue interval has elapsed. If it is judged as a result that the interval has elapsed, the flow proceeds to Step S75; if not, the process is ended.

Step S75:

The server 20 executes an OCSP issuing process. On completion of the issuing process, the OCSP information is updated using the date and time at that moment.

According to the process described above, the OCSP issue intervals can be freely set in accordance with importance of transactions, for example. Accordingly, the OCSP issue intervals can be set to optimum values according to kinds of transactions, making it possible to lighten the processing load on the server 20 and thus to increase the processing speed of the overall system.

A fifth embodiment of the present invention will be now described.

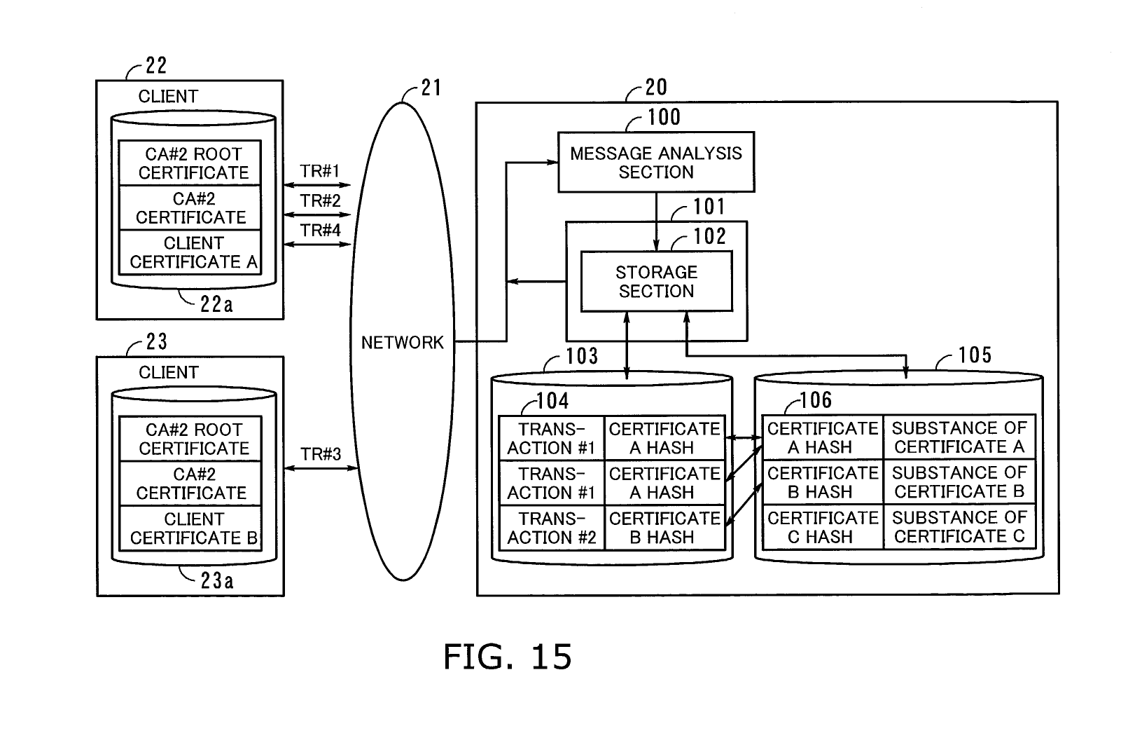

FIG. 15 is a block diagram showing the fifth embodiment of the present invention. Various functions illustrated in the block diagram are accomplished when a predetermined program stored in the HDD 20d in FIG. 3 is executed.

As shown in the figure, the fifth embodiment of the present invention comprises a message analysis section 100, a security management section 101, and databases 103 and 105.

The message analysis section 100 analyzes a message transmitted from the clients 22 and 23.

The security management section 101, which comprises a storage section 102, stores information about transactions conducted with respect to the clients in the database 103.

The database 103 has a table 104 in which transactions and certificate hashes obtained by hashing certificates are stored in a manner associated with each other.

The database 105 has a table 106 in which are stored the certificate hashes and substances of the certificates in a manner associated with each other.

Operation of the above embodiment will be now described.

When accessed from the client 22, for example, the message analysis section 100 analyzes the message transmitted from the client 22 and determines whether or not the client is an authentic client. If the accessing client is an authentic client, the access is permitted.

Then, a transaction #1 (TR#1) is conducted with the client 22. On completion of the transaction, the storage section 102 hashes a client certificate A possessed by the client 22, and stores the obtained certificate A hash in the table 104 of the database 103 in a manner associated with the transaction name (transaction #1).

At this time, the storage section 102 searches the table 106 of the database 105 by using the certificate A hash as a key, and terminates the process if a matching hash exists. If no matching hash exists, the hash in question (certificate A hash) and the certificate itself (or data identifying the certificate) are stored in the table 106.

If a new transaction TR#2 is conducted thereafter with the client 22, it is judged upon completion of the transaction that the certificate A is already registered in the database 105. Accordingly, data indicating the transaction #2 and the certificate A hash are stored in the table 104 of the database 103.

Subsequently, if a new transaction TR#3 is conducted with the client 23 and if a client certificate B of the client 23 is not registered yet, a certificate B hash and the substance of the certificate B are stored in the table 106 of the database 105. Also, data identifying the transaction #2 and the certificate B hash are registered in the table 104 of the database 103.

A certificate has a data volume of about 1000 bytes while a certificate hash has a data volume of about 10 to 20 bytes. Thus, compared with the case of holding certificates as a log of transactions, the capacity required of the database can be reduced.

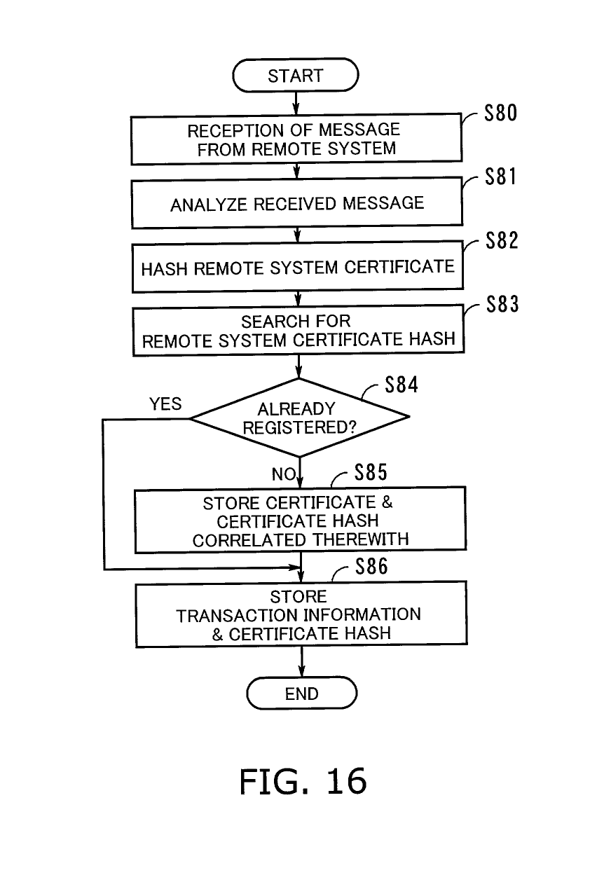

Referring now to the flowchart of FIG. 16, an exemplary process for performing the aforementioned function will be described. The process shown in FIG. 16 is executed when a transaction with a remote system is initiated. Upon start of the process shown in the flowchart, the following steps are executed.

Step S80:

The message analysis section 100 receives a message from a remote system.

Step S81:

The message analysis section 100 executes a process for analyzing the received message.

Step S82:

The storage section 102 hashes the certificate of the remote system to obtain a certificate hash.

Step S83:

Using the certificate hash obtained in Step S82 as a key, the storage section 102 searches the database 105 for a matching certificate hash.

Step S84:

The storage section 102 determines whether or not the certificate hash is already registered. If the certificate hash is already registered, the flow proceeds to Step S86; if not, the flow proceeds to Step S85.

Step S85:

The storage section 102 correlates the certificate with the certificate hash and stores the thus-correlated data in the table 106 of the database 105.

Step S86:

The storage section 102 correlates transaction information identifying the transaction with the certificate hash obtained in Step S82, and stores the thus-correlated data in the table 104 of the database 103.

In the process described above, each time a transaction is completed, a certificate hash obtained by hashing a certificate is registered instead of storing the certificate itself. Thus, compared with the case of registering a certificate itself, the required storage capacity can be reduced.

In the above embodiment, the certificate hash is used as information for interrelating the databases 103 and 105 with each other, but some other data such as a serial number may be used instead. Also with the method using a serial number, the required storage capacity can be reduced as in the case of using the hash.

The processing function described above can be implemented by a server computer of a client-server system. In this case, a server program is provided in which are described processes for performing the function of the server 20. The server computer executes the server program in compliance with a request from a client computer, whereby the aforementioned processing function is performed by the server computer and the processing results are presented to the client computer.

The server program having the processes described therein may be recorded on a server computer-readable recording medium. The server computer-readable recording medium includes magnetic recording device, optical disk, magneto-optical recording medium, semiconductor memory, etc. Such a magnetic recording device may be hard disk drive (HDD), flexible disk (FD), magnetic tape, etc. As the optical disk, DVD (Digital Versatile Disk), DVD-RAM (Random Access Memory), CD-ROM (Compact Disk Read Only Memory), CD-R (Recordable)/RW (ReWritable) or the like may be used. The magneto-optical recording medium includes MO (Magneto-Optical disk) etc.

To distribute the server program, portable recording media, such as DVD and CD-ROM, on which the server program is recorded may be put on sale.

The server program recorded on a portable recording medium, for example, is stored in the storage device of the server computer which is to execute the server program. The server computer reads in the server program from its storage device and performs processes in accordance with the server program. Alternatively, the server computer may read in the server program directly from the portable recording medium to perform processes in accordance with the server program.

As described above, the present invention provides a program for causing a computer to function as an information processing device for exchanging information with other information processing devices via a network, wherein the program causes the computer to function as user identification information input means for receiving user identification information input thereto and identifying a user, certificate acquiring means for acquiring a certificate certifying authenticity of the user, correspondence storing means for storing information indicating a correspondence between the user identification information and the certificate, certificate identifying means responsive to access from a certain user, for identifying, based on user identification information from the certain user, a corresponding certificate, and user certification means for verifying based on the certificate identified by the certificate identifying means whether or not the certain user is an authentic user. It is therefore possible to enhance the security of the information processing device, for example, a server which handles a plurality of transactions.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A program for causing a computer to function as an information processing device for exchanging information with other information processing devices via a network, wherein the program causes the computer to function as:
user identification information input means for receiving user identification information input thereto and identifying a user;
certificate acquiring means for acquiring a certificate certifying authenticity of the user;
correspondence storing means for storing information indicating a correspondence between the user identification information and the certificate;
certificate identifying means, responsive to access from a certain user, for identifying, based on user identification information from the certain user, a corresponding certificate; and
user certification means for verifying based on the certificate identified by the certificate identifying means whether or not the certain user is an authentic user.

2. The program according to claim 1, wherein the correspondence storing means stores a correspondence between one user and one or more certificates.

3. The program according to claim 1, wherein the program causes the computer to additionally function as:
user information extracting means for extracting user information indicative of a user from information transmitted from the different information processing device;
certificate identification information extracting means for extracting certificate identification information identifying a certificate from the information transmitted from the different information processing device;
user identification information acquiring means for looking up the certificate identification information to acquire corresponding user identification information from the correspondence storing means; and
information processing device certification means for comparing the user identification information with the user information to verify authenticity of the different information processing device.

4. The program according to claim 1, wherein the program causes the computer to additionally function as:
root certification information storing means for storing root certification information of the different information processing device;
root certification information acquiring means for acquiring root certification information from information transmitted from the different information processing device; and
root certification means for comparing the root certification information acquired by the root certification information acquiring means with the root certification information stored in the root certification information storing means, to verify authenticity of root.

5. The program according to claim 4, wherein the root certification information storing means stores data obtained by processing the root certification information by using a one-way function, and
the root certification means processes the root certification information acquired by the root certification information acquiring means, by using the one-way function, and compares obtained data with the data stored in the root certification information storing means, to verify authenticity of the root.

6. The program according to claim 1, wherein the program causes the computer to additionally function as:
certificate storing means for storing a certificate certifying authenticity of the different information processing device;
inquiry means for inquiring of an outside organization about authenticity of the certificate stored in the certificate storing means; and
inquiry interval setting means for setting intervals at which the inquiry means inquires of the outside organization.

7. The program according to claim 6, wherein the inquiry interval setting means sets the intervals in accordance with importance of a transaction associated with the different information processing device.

8. The program according to claim 1, wherein the program causes the computer to additionally function as:
log storing means for storing, as a log on a transaction-by-transaction basis, a process conducted with respect to the different information processing device; and
certificate identification information writing means for writing certificate identification information identifying a certificate related to the transaction, in a manner associated with the log.

9. The program according to claim 8, wherein the certificate identification information comprises data obtained by processing the certificate by using a one-way function.

10. The program according to claim 8, wherein the certificate identification information comprises a serial number assigned uniquely to the certificate.

11. An information processing method for exchanging information with other information processing devices via a network, comprising:
a user identification information input step of receiving input user identification information identifying a user;
a certificate acquiring step of acquiring a certificate certifying authenticity of the user;
a correspondence storing step of storing information indicating a correspondence between the user identification information and the certificate;
a certificate identifying step of identifying, in response to access from a certain user and based on user identification information from the certain user, a corresponding certificate; and
a user certification step of verifying based on the certificate identified in the certificate identifying step whether or not the certain user is an authentic user.

12. An information processing device for exchanging information with other information processing devices via a network, comprising:
user identification information input means for receiving user identification information input thereto and identifying a user;
certificate acquiring means for acquiring a certificate certifying authenticity of the user;
correspondence storing means for storing information indicating a correspondence between the user identification information and the certificate;
certificate identifying means, responsive to access from a certain user, for identifying, based on user identification information from the certain user, a corresponding certificate; and
user certification means for verifying based on the certificate identified by the certificate identifying means whether or not the certain user is an authentic user.
